(19) United States
(12) Patent Application Publication
(10) Pub. No.: US 2017/0041155 A1
(43) Pub. Date: Feb. 9, 2017

(54) Policy Charging and Enforcement Synchronization

(71) Applicant: Cisco Technology, Inc., San Jose, CA (US)

(72) Inventor: Neeraj Surana, Pune (IN)

(21) Appl. No.: 14/817,775

(22) Filed: Aug. 4, 2015

(51) Int. Cl. H04L 12/14; H04M 15/00

(52) U.S. Cl. CPC H04L 12/1407; H04M 15/66

(57) ABSTRACT

Synchronization issues within a policy and charging control system are avoided by enabling a PCEF to notify the PCRF that it will ignore one or more credit control answers. The PCEF sends a first credit control request to the PCRF in the policy and charging control system for access to resources in a network. Before receiving a first credit control answer corresponding to the first credit control request, the PCEF sends a second credit control request to the PCRF. The second credit control request includes an indication that the first credit control answer will be ignored. The PCEF receives the first credit control answer from the PCRF, but does not process the first credit control answer. The PCEF receives a second credit control answer from the PCRF and processes the second credit control answer without processing the first credit control answer.

### TECHNICAL FIELD

The present disclosure relates generally to policy and charging control of mobile device access to public data networks.

### BACKGROUND

Policy and charging control systems are used to assign network resources (e.g., 4G Long Term Evolution (LTE) wireless network resources) to user devices according to rules and policies for quality-of-service, charging, and/or access control. A policy and charging Rules function (PCRF) manages the rules and policies, and a policy and charging enforcement function (PCEF) applies the rules to individual service data flows between the user devices and the public data network. To determine which rules and policies apply to a specific service data flow, the PCEF sends a credit control request to the PCRF. The PCRF responds with a credit control answer indicating one or more rules and/or policies to apply to the service data flow.

The credit control answers from the PCRF are processed by the PCEF in sequence, since each credit control answer may change parameters in the service data flow. If the PCEF and PCRF are not synchronized, then the user experience may be impacted. Charging inconsistencies may also result from policies being unsynchronized between the PCEF and PCRF.

### BRIEF DESCRIPTION OF THE DRAWINGS

FIG. 1 shows a policy and charging control system that maintains synchronization between the PCEF and the PCRF, according to an example embodiment.

FIG. 2A is a simplified block diagram of a public network gateway performing the operations of the PCEF, according to an example embodiment.

FIG. 2B is a simplified block diagram of a server performing the operations of the PCRF, according to an example embodiment.

FIG. 3 is a ladder diagram illustrating messages that are used to synchronize the PCEF and PCRF, according to an example embodiment.

FIG. 4 is a flowchart showing operations taken by the public network gateway implementing the PCEF to maintain the synchronization between the PCEF and the PCRF, according to an example embodiment.

FIG. 5 is a flowchart showing operations taken by a server implementing the PCRF to maintain the synchronization between the PCEF and the PCRF, according to an example embodiment.

### DESCRIPTION OF EXAMPLE EMBODIMENTS

### Overview

A computer-implemented method is provided for a PCEF to ignore credit control answers that may cause synchronization issues within a policy and charging control system. The method comprises sending a first credit control request to a PCRF in the policy and charging control system for access to resources in a network. The first credit control request is associated with a communication session in the network. Before receiving a first credit control answer corresponding to the first credit control request, the PCEF sends a second credit control request to the PCRF. The second credit control request includes an indication that the first credit control answer will be ignored. The PCEF receives the first credit control answer from the PCRF, but does not process the first credit control answer. The PCEF receives a second credit control answer from the PCRF and processes the second credit control answer without processing the first credit control answer.

### Description of Example Embodiments

A policy and charging control system may cause the PCEF to report various events to the PCRF to determine if and how the allocated resources may change based on the reported events. Some of these events include a revalidation timeout, a change in the access node gateway, or a change in radio access technology. Each event triggers the PCEF to send a credit control request to the PCRF. Since each of these events may be triggered independently, the PCEF may issue a second credit control request before receiving the credit control answer associated with the first credit control request. The unanswered credit control request may create rule dependency issues when the second credit control request is sent without accounting for any rule changes that will be received in the first credit control answer.

The PCRF may enable multiple events to be reported at the PCEF. The PCEF sends an update credit control request (CCR-U) for those events as and when the trigger hits. In some instances, a second trigger may be tripped and generate a second CCR-U before the update credit control answer (CCA-U) for the first CCR-U has been received. In other words, there may be multiple outstanding CCR-U requests outstanding from the PCEF, and there may some instances in which the PCEF cannot process the first CCA-U.

In one specific example, a call has been set up at the public data network gateway (PGW) with an S5/S8 General Packet Radio Service Tunneling Protocol (GTP) tunnel and the PCRF has enabled event reporting for revalidation timeout, access node gateway change (AN_GW CHANGE), and radio access technology change (RAT_CHANGE). If a revalidation timeout triggers at the PCEF, it will generate a CCR-U directed towards the PCRF. However, before the CCA-U responding to the revalidation trigger is received by the PCEF, an external trigger such as a Create Session Request (CSR) is received by the PCEF. The CSR directs the call to be handed off to a Wi-Fi® network, which causes another CCR-U to be generated for a RAT_CHANGE and an AN_GW_CHANGE. When the PCEF receives the first CCA-U for the first CCR-U, it may cause an Update Bearer Request (UBR) to be generated due to a change in Access Point Name Aggregate Maximum Bit Rate (APN-AMBR), quality of service (QoS), or other PCC/charging rules. Since the PCEF has already received a CSR for the handoff, the PCEF should not trigger an UBR on the old access (S5/S8) and may discard the first CCA-U or drop the call. When the second CCA-U is received and processed at the PCEF, it may fail due to some rule dependency from the previous CCA-U. In that instance, the PCRF and PCEF will be out of synchronization and the call may be dropped.

In another example, the first CCR-U may be trigger by an “out of quota” expiry or revalidation timeout. The PGW may receive an access side transaction (e.g., for an access technology change or circuit-switched to packet-switched handover) causing the second CCR-U. In this case, the rules (QoS, APN-AMBR, etc.) received in the first CCA-U may be irrelevant because they are for the old access technology. The PCEF may not confirm that these rules shall be applied on new access subscribers, leading to incorrect charging and control rules.

The techniques presented herein add a new attribute-value pair (AVP) for a CCR-U from the PCEF to the PCRF. The new attribute-value pair “Discarded-CC-Request-Number” is added to the second/latter CCR-U, and will contain the credit control request number of the first/previous CCR-U. When the PCRF receives the second CCR-U with this new attribute-value pair, it will assume that the previous/first CCA-U will be dropped/ignored at the PCEF and the PCRF may resend attribute-value pairs in the latter/second CCA-U. The PCEF silently drops the previous/first CCA-U and does not take any action based on this CCA-U. These actions maintain the synchronization between the PCEF and PCRF as both are aware that the first CCA-U has been dropped.

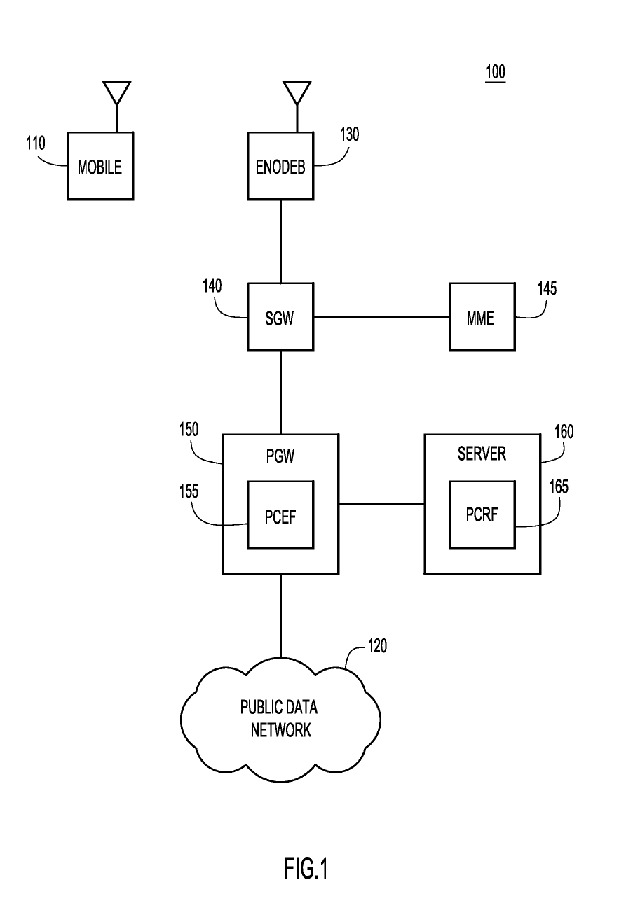

Referring now to FIG. 1, a simplified block diagram of a system 100 shows a mobile device 110 configured to access a public data network 120 though a 4G LTE network infrastructure that includes a policy and charging control system. The network infrastructure includes Evolved Node B (EnodeB) 130 to communicate wirelessly and send/receive calls with the mobile device 110. A serving gateway 140 handles communications from EnodeB 130 and coordinates the call setup and bearers for the calls involving the mobile device 110. In some instances, a mobility management entity 145 may also coordinate communications for the mobile device 110 through the serving gateway 140.

The public network gateway 150 communicates with the serving gateway 140 to generate and maintain the communication links between the mobile device 110 and the public data network 120. The public network gateway 150 includes a PCEF 155 of the policy and charging control system to enforce rules on the communication links. To determine the rules that the PCEF will enforce, the public network gateway 150 communicates with a server 160 that includes the PCRF 165 responsible for determining the policy and charging control rules for each call.

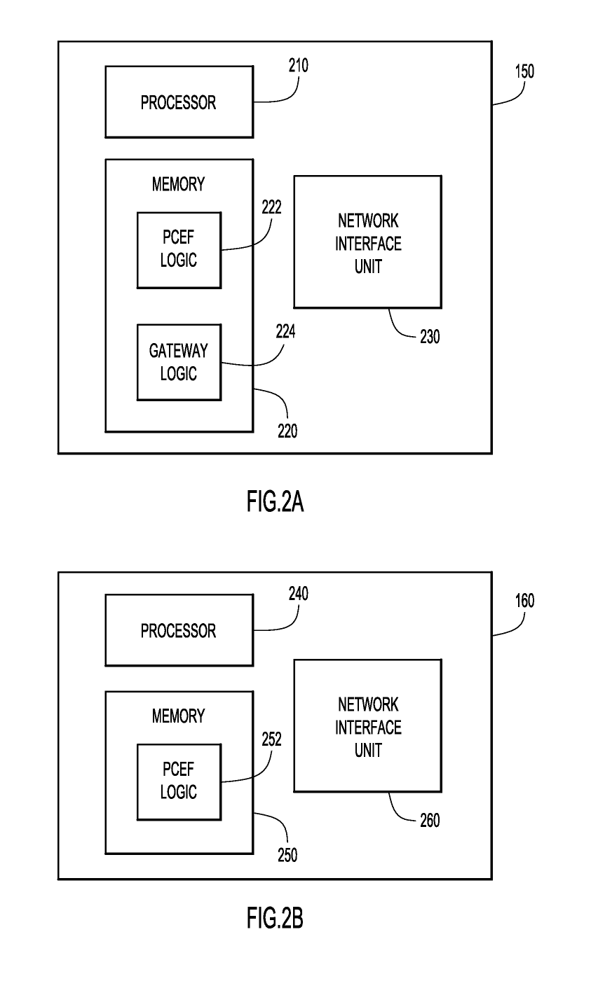

Referring now to FIG. 2A, a simplified block diagram shows an example of a public network gateway 150. The public network gateway 150 includes a processor 210 to process instructions relevant to the operations of the device, and memory 220 to store a variety of data and software instructions (e.g., call data, policy and charging control rules, etc.), including PCEF logic 222 and gateway logic 224. The public network gateway 150 also includes a network interface unit 230 configured to communicate with computing devices and network elements over a computer network. The computer network may include a wireless network, a wired network, a local area network, a wide area network, and/or other types of networks configured to communicate data between computing devices.

Memory 220 may include read only memory (ROM), random access memory (RAM), magnetic disk storage media devices, optical storage media devices, flash memory devices, electrical, optical, or other physical/tangible (e.g., non-transitory) memory storage devices. The processor 210 is, for example, a microprocessor or microcontroller that executes instructions for implementing the processes related to the PCEF described herein. Thus, in general, the memory 220 may include one or more tangible (non-transitory) computer readable storage media (e.g., a memory device) encoded with software (e.g., the network path selection logic) comprising computer executable instructions and when the software is executed (by the processor 210) it is operable to perform the operations described herein.

Referring now to FIG. 2B, a simplified block diagram shows an example of a server 160 implementing the PCRF 165. The server 160 includes a processor 240 to process instructions relevant to the operations of the device, and memory 250 to store a variety of data and software instructions (e.g., user account data, Policy and Charging Control rules, etc.), including PCRF logic 252. The server 160 also includes a network interface unit 260 configured to communicate with computing devices and network elements over a computer network. The computer network may include a wireless network, a wired network, a local area network, a wide area network, and/or other types of networks configured to communicate data between computing devices.

Memory 250 may include ROM, RAM, magnetic disk storage media devices, optical storage media devices, flash memory devices, electrical, optical, or other physical/tangible (e.g., non-transitory) memory storage devices. The processor 240 is, for example, a microprocessor or microcontroller that executes instructions for implementing the processes related to the PCRF described herein. Thus, in general, the memory 250 may include one or more tangible (non-transitory) computer readable storage media (e.g., a memory device) encoded with software (e.g., the network path selection logic) comprising computer executable instructions and when the software is executed (by the processor 210) it is operable to perform the operations described herein.

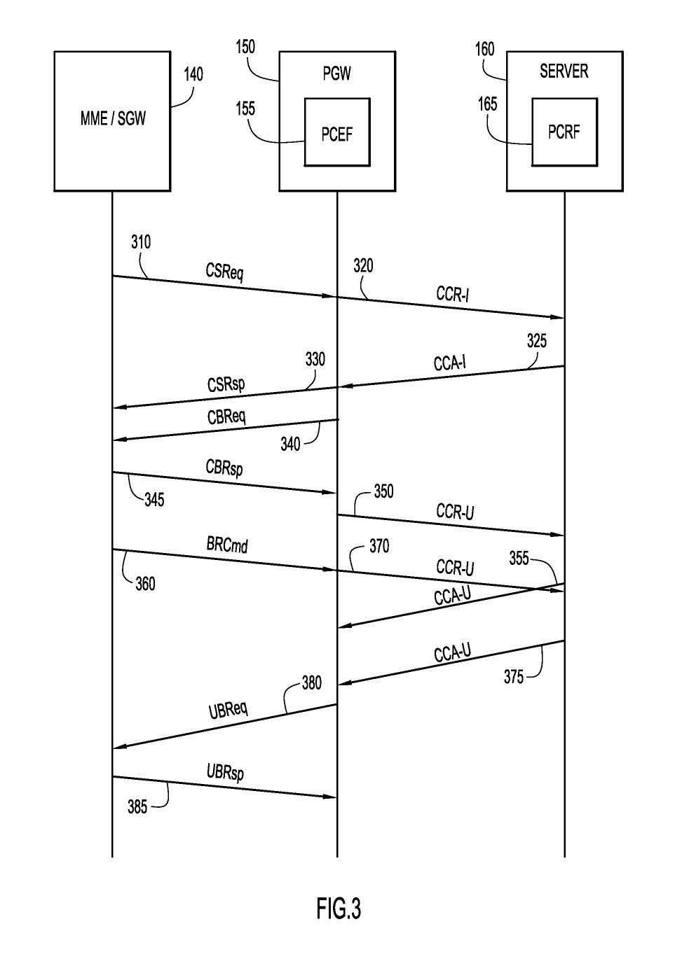

Referring now to FIG. 3, a ladder diagram is provided that illustrates messages exchanged between elements of the policy and charging control system. Initially, the serving gateway 140 receives a request (e.g., from the mobility management entity 145) to set up a call for a mobile device. The serving gateway 140 sends a call setup request 310 to the public gateway 150 that implements the PCEF 155. The PCEF 155 sends an initial credit control request 320 to the PCRF 165. The PCRF 165 responds to the initial credit control request 320 with an initial credit control answer 325. In one example, the initial credit control answer 325 includes event triggers that will cause the PCEF 155 to send update credit control requests. The event triggers may include user location information, a revalidation timeout value, and/or a default Evolved Packet System bearer quality-of-service change. The public network gateway 150 responds to the call setup request 310 after receiving the initial credit control answer by sending a call setup response 330 to the serving gateway 140.

The public network gateway 150 sends a create bearer request 340 to the serving gateway 140 in order to create dedicated bearers for the Policy and Charging Control rules received in the initial credit control answer 325. The serving gateway 140 responds with a create bearer response 345 to complete the bearer creation process.

In one example, an internal trigger, such as a revalidation timeout, causes the PCEF 155 to send an update credit control request 350 to the PCRF 165, which responds with an update credit control answer 355. Before the PCEF 155 receives the update credit control answer 355, the PCEF 155 receives a bearer request command 360 from the serving gateway 140. In response to the bearer request command 360, the PCEF 155 sends a second update credit control request 370 to the PCRF 165. Since the PCEF 155 has not received the first update credit control answer 355, the PCEF 155 also includes an indication that it will ignore the update credit control answer 355 when it arrives at the PCEF 155. The indication may include an attribute-value pair comprising an attribute named “Discarded-CC-Request-Number” and a value of the identification number of the update credit control request 350.

In response to the second update credit control request 370, the PCRF 165 sends a second update credit control request 375. The PCRF 165 may include one or more attribute-value pairs from the credit control answer 355 in the second credit control answer 375, since the credit control request 370 indicated that any attribute-value pairs from the credit control answer 355 will be ignored. Alternatively, the PCRF 165 may determine that the information in the credit control answer 375 does not require the credit control answer 355 to be processed (e.g., any policy changes made in response to the credit control answer 375 would override any policy changes made in response to the ignored credit control answer 355), and leave the credit control answer 375 unchanged. In another example, the PCRF 165 may alter one or more attribute-value pairs in the credit control answer 375 to account for the PCEF 155 ignoring the previous credit control answer 355.

Once the PCEF 155 receives the credit control answer 355, it will ignore it and wait for the subsequent credit control answer 375. After receiving the credit control answer 375, the PCEF will process any policy changes and send an update bearer request 380 to the serving gateway 140. In one example, the update bearer request 380 includes the same Procedure Transaction Identifier that was received with the bearer request command 360. The serving gateway 140 responds with an update bearer response 385.

While FIG. 3 and the description thereof only describes the PCEF 155 ignoring a first credit control answer that was received after sending a second credit control request, more than one credit control answer may be ignored if the corresponding credit control answers are not received from the PCRF 165 before the PCEF 155 is directed to send another credit control request. Each credit control request sent by the PCEF 155 before the credit control answer corresponding to the previous credit control request is received will include an indication that the credit control answer corresponding to the previous credit control request will be ignored. The PCRF 165 will be responsible for making any necessary changes to the subsequent credit control answers in order to account for all of the ignored credit control answers. In general, the PCEF 155 may ignore any or all of the credit control answers corresponding to any credit control request other than the most recently sent credit control request. The PCRF 165 may process any/all of the outstanding credit control requests and consolidate the attribute-value pairs into a single credit control answer.

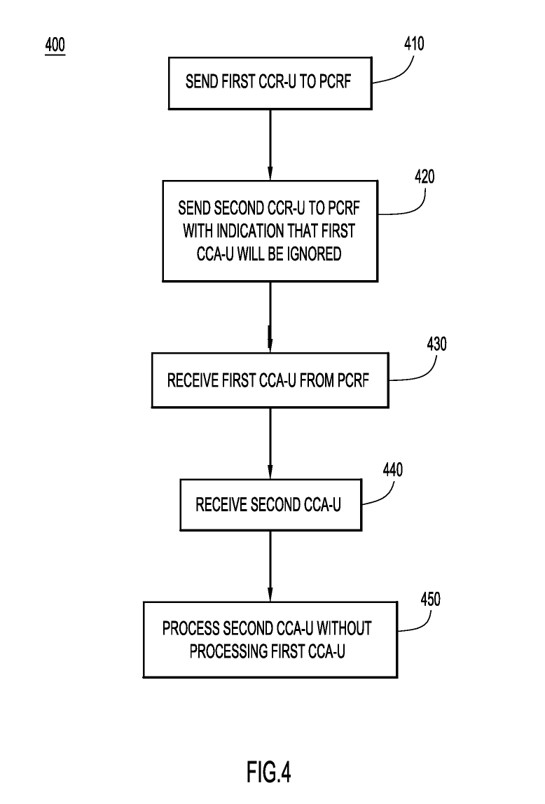

Referring now to FIG. 4, a flowchart is shown of an example process 400 of the operations of the PCEF 155 in maintaining synchronization with the PCRF 165. In step 410, the PCEF 155 sends a first credit control request to the PCRF 165. The first credit control request may be an update credit control request after the initial call setup is complete. In step 420, the PCEF 155 sends a second credit control request to the PCRF. Since the PCEF 155 has not received a first credit control answer corresponding to the first credit control request, the PCEF 155 includes an indication that the first credit control answer corresponding to the first credit control request will be ignored.

In step 430, the PCEF 155 receives the first credit control answer corresponding to the first credit control request. However, since the first credit control answer was not received before sending the second credit control request, the first credit control answer is ignored. In step 440, the PCEF 155 receives a second credit control answer corresponding to the second credit control request. The PCEF 155 processes the second credit control answer without processing the first credit control answer in step 450.

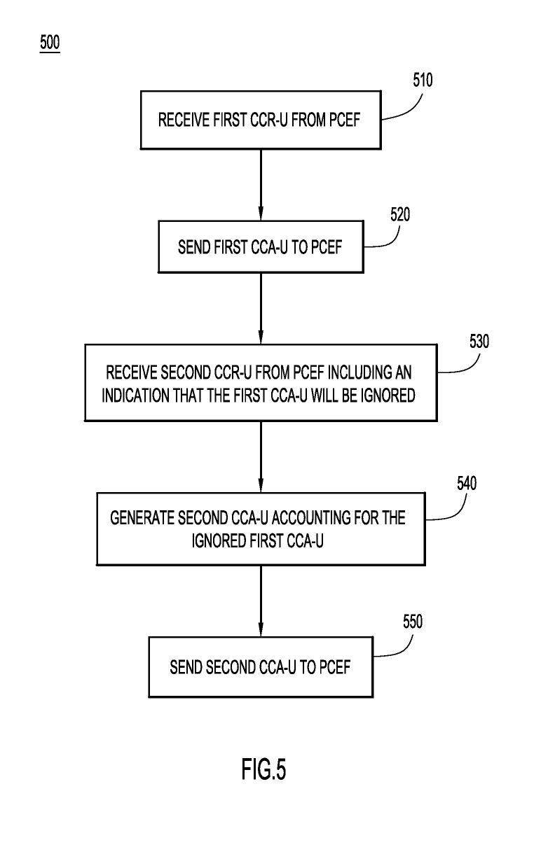

Referring now to FIG. 5, a flowchart is shown of an example process 500 of the operations of the PCRF 165 in maintaining synchronization with the PCEF 155. In step 510, the PCRF 165 receives a first credit control request from the PCEF 155. The first credit control request may be an update credit control request after the initial call setup is complete. In step 520, the PCRF 165 sends a first credit control answer in response to the first credit control request. In step 530, the PCRF 165 receives a second credit control request. The second credit control request includes an indication that the first credit control answer will be ignored by the PCEF 155. The indication may be an attribute-value pair with an attribute of “Discarded Credit Control Request Number” and a value of an identifying number corresponding to the first credit control request.

In step 540, the PCRF 165 generates a second credit control answer corresponding to the second credit control request. The second credit control answer accounts for any necessary policy changes from the first credit control answer that will be ignored by the PCEF 155 when it receives the first credit control answer. The second credit control answer may include one or more attribute-value pairs from the first credit control answer. Alternatively, the PCRF 165 may modify one or more attribute-value pairs of the second credit control answer to account for changes that will have been ignored from the first credit control answer. The PCRF 165 may determine that no changes to the second credit control answer are necessary, since any changes from the ignored first credit control answer would be overridden by the second credit control answer. In step 550, the PCRF 165 sends the second credit control answer to the PCEF 155.

In summary, the techniques provided herein enable the PCEF and PCRF to avoid falling out of synchronization for multiple simultaneous credit control requests outstanding from the PCEF. As the number of event reporting triggers increases, this allows the PCEF to enforce the correct charging and policy rules between two network nodes on a consistent basis. Also, these techniques allow the PCRF to take action on multiple credit control requests that it receives so that it can send consolidated attribute-value pairs (AVPs) in an updated credit control answer.

In one form, a computer-implemented method is provided for a policy and charging enforcement function to ignore credit control answers that may cause synchronization issues within the policy and charging control system. The method comprises sending a first credit control request to a policy and charging rules function in a policy and charging control system for access to resources in a network. The first credit control request is associated with a communication session in the network. Before receiving a first credit control answer corresponding to the first credit control request, the policy and charging enforcement function sends a second credit control request to the policy and charging rules function. The second credit control request includes an indication that the first credit control answer will be ignored. The policy and charging enforcement function receives the first credit control answer from the policy and charging rules function, but does not process the first credit control answer. The policy and charging enforcement function receives a second credit control answer from the policy and charging rules function and processes the second credit control answer without processing the first credit control answer.

In another form, a computer-implemented method is provided for a policy and charging enforcement function to be notified that a credit control answer will be ignored by the policy and charging enforcement function, and accounting for the ignored credit control answer to maintain synchronization within a policy and charging control system. The method comprises receiving a first credit control request from the policy and charging enforcement function in a policy and charging control system for access to resources in a network. The first credit control request is associated with a communication session in the network. The policy and charging rules function sends a first credit control answer associated with the first credit control request to the policy and charging enforcement function. The policy and charging rules function receives from the policy and charging enforcement function a second credit control request that includes an indication that the first credit control answer will be ignored. A second credit control answer associated with the second credit control request is generated such that the second credit control answer accounts for the policy and charging enforcement function ignoring the first credit control answer. The second credit control answer is sent from the policy and charging rules function to the policy and charging enforcement function.

In yet another form, a policy and charging control system is provided that maintains synchronization between the policy and charging enforcement function and the policy and charging rules function. The system comprises a server configured to carry out a policy and charging rules function and a public network gateway configured to carry out a policy and charging enforcement function. The server carries out the policy and charging rules function for access to resources in a network by responding to credit control requests with corresponding credit control answers. The public network gateway carries out the policy and charging enforcement function by sending a plurality of credit control requests to the policy and charging rules function in the server. One of the credit control requests includes an indication that a credit control answer corresponding to a prior credit control request will be ignored. The server is further configured to receive the credit control request indicating that the credit control answer corresponding to the prior credit control request will be ignored by the public network gateway. The server is configured to update a subsequent credit control answer to account for the public network gateway ignoring the credit control answer corresponding to the prior credit control request.

The above description is intended by way of example only. Various modifications and structural changes may be made therein without departing from the scope of the concepts described herein and within the scope and range of equivalents of the claims. For example, the techniques described herein may be applied to a General Packet Radio Service (GPRS) as part of a Gateway GPRS Service Node (GGSN), as well as a Third Generation Partnership Project (3GPP) and Long Term Evolution (LTE) architecture.

What is claimed is:

1. A method comprising:
sending a first credit control request from a policy and charging enforcement function to a policy and charging rules function in a policy and charging control system for access to resources in a network, the first credit control request associated with a communication session in the network;
before receiving a first credit control answer associated with the first credit control request, the policy and charging enforcement function sending a second credit control request to the policy and charging rules function, the second credit control request including an indication that the first credit control answer will be ignored;
receiving at the policy and charging enforcement function from the policy and charging rules function the first credit control answer associated with the first credit control request;
receiving at the policy and charging enforcement function from the policy and charging rules function, a second credit control answer associated with the second credit control request; and
processing the second credit control answer by the policy and charging enforcement function without processing the first credit control answer.

2. The method of claim 1, further comprising:
sending an update bearer request to a serving gateway; and
receiving an update bearer response associated with the update bearer request.

3. The method of claim 2, further comprising receiving an event trigger from the serving gateway, wherein the second credit control request is sent in response to the event trigger.

4. The method of claim 1, wherein the second credit control request is sent in response to an internal trigger.

5. The method of claim 1, wherein the first credit control answer comprises at least one attribute-value pair that defines a characteristic of the communication session.

6. The method of claim 5, wherein the second credit control answer includes the at least one attribute-value pair from the first credit control answer.

7. The method of claim 1, wherein the first credit control request and the second credit control request are update requests.

8. A method comprising:
receiving at a policy and charging rules function a first credit control request from a policy and charging enforcement function in a policy and charging control system for access to resources in a network, the first credit control request associated with a communication session in the network;
sending from the policy and charging rules function to the policy and charging enforcement function, a first credit control answer associated with the first credit control request;
receiving from the policy and charging enforcement function a second credit control request, the second credit control request including an indication that the first credit control answer will be ignored by the policy and charging enforcement function;
generating a second credit control answer associated with the second credit control request, the second credit control answer accounting for the policy and charging enforcement function ignoring the first credit control answer; and
sending the second credit control answer from the policy and charging rules function to the policy and charging enforcement function.

9. The method of claim 8, wherein the first credit control answer comprises at least one attribute-value pair that defines a characteristic of the communication session.

10. The method of claim 9, wherein the second credit control answer accounts for the policy and charging enforcement function ignoring the first credit control answer by including the at least one attribute-value pair from the first credit control answer.

11. The method of claim 8, further comprising:
updating at least one attribute-value pair in the second credit control answer to reflect changes initiated by the first credit control request.

12. The method of claim 8, wherein the first credit control request and the second credit control request are update requests.

13. A system comprising:
a server configured to carry out a policy and charging rules function in a policy and charging control system for access to resources in a network by responding to credit control requests with corresponding credit control answers; and
a public network gateway configured to carry out a policy and charging enforcement function by sending a plurality of credit control requests to the policy and charging rules function in the server, one of the credit control requests including an indication that a credit control answer corresponding to a prior credit control request will be ignored,
wherein the server is configured to receive the credit control request indicating that the credit control answer corresponding to the prior credit control request will be ignored by the public network gateway, and update a subsequent credit control answer to account for the public network gateway ignoring the credit control answer corresponding to the prior credit control request.

14. The system of claim 13, further comprising a serving gateway configured to create and update bearer tables associated with mobile device communication sessions,
wherein the public network gateway is further configured to:
send an update bearer request to the serving gateway; and
receive an update bearer response associated with the update bearer request.

15. The system of claim 14, wherein the serving gateway is configured to send an event trigger to the public network gateway, and the public network gateway is configured to send a second credit control request in response to the event trigger.

16. The system of claim 13, wherein the subsequent credit control request is sent in response to an internal trigger.

17. The system of claim 13, wherein the corresponding credit control answers comprise at least one attribute-value pair.

18. The system of claim 17, wherein the subsequent credit control answer includes at least one attribute-value pair from the credit control answer that will be ignored.

19. The system of claim 13, wherein the plurality of credit control requests are update requests.

20. The system of claim 13, wherein the server is configured to update at least one attribute-value pair in the subsequent credit control answer to reflect changes initiated by the prior credit control request.
